(19) United States
(12) Patent Application Publication
(10) Pub. No.: US 2026/0286217 A1
(43) Pub. Date: Sep. 24, 2026

(54) Indenonaphthopyrans Having Perfluoroalkyl Substituted Aryl / Heteroaryl Sulfide at Position-11

(71) Applicant: Transitions Optical, Ltd., Tuam (IE)

(72) Inventors: Chien-Yang Chiu, Export, PA (US); Beon-Kyu Kim, Gibsonia, PA (US); Robert W. Walters, Murrysville, PA (US); Wenjing Xiao, Murrysville, PA (US)

(21) Appl. No.: 19/484,592

(22) PCT Filed: May 17, 2023
(86) PCT No.: PCT/EP2023/063277

§ 371 Date: Nov. 14, 2025

(51) Int. Cl. C09K 9/02

(52) U.S. Cl. CPC C09K 9/02; C09K 2211/1033; C09K 2211/1088

(57) ABSTRACT

The present invention relates to indenonaphthopyran compounds represented by the following Formula (I). With reference to Formula (I), m, n, and R⁴-R⁷ are as described in the specification. With further reference to Formula (I), R¹ is aryl substituted with at least one perfluoroalkyl group, or heteroaryl substituted with at least one perfluoroalkyl group; R² is alkoxy; and R³ is alkoxy, amino, or substituted or unsubstituted nitrogen-containing heterocycle, provided that when R³ is other than alkoxy, R³ is covalently CA bonded to position-7 by a nitrogen atom. The present invention also relates to photochromic compositions and photochromic articles that include indenonaphthopyran compounds represented by Formula (I).

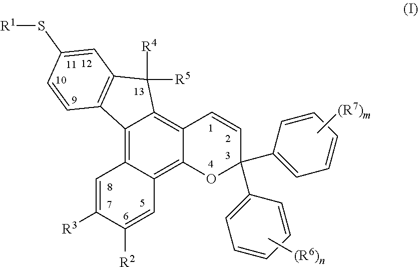

### FIELD

The present invention relates to indenonaphthopyran compounds that have a perfluoroalkyl substituted aryl or perfluoroalkyl substituted heteroaryl group bonded to position-11 by a sulfide linkage, and photochromic compositions and photochromic articles that include such compounds.

### BACKGROUND

In response to certain wavelengths of electromagnetic radiation (or “actinic radiation”), photochromic compounds, such as indenonaphthopyrans (or indeno-fused naphthopyrans), typically undergo a transformation from one form or state to another form, with each form having a characteristic or distinguishable absorption spectrum associated therewith. Typically, upon exposure to actinic radiation, many photochromic compounds are transformed from a closed-form, which corresponds to an unactivated (or bleached, e.g., substantially colorless) state of the photochromic compound, to an open-form, which corresponds to an activated (or colored) state of the photochromic compound. In the absence of exposure to actinic radiation, such photochromic compounds are reversibly transformed from the activated (or colored) state, back to the unactivated (or bleached) state. Compositions and articles, such as eyewear lenses, that contain photochromic compounds or have photochromic compounds applied thereto (e.g., in form of a photochromic coating composition) typically display colorless (e.g., clear) and colored states that correspond to the colorless and colored states of the photochromic compounds contained therein or applied thereto.

It is generally desirable that photochromic indenonaphthopyran compounds provide a significant level of darkness when exposed to actinic radiation. It is also generally desirable that photochromic indenonaphthopyran compounds also quickly fade to the unactivated (or bleached) state in the absence of exposure to actinic radiation. Indenonaphthopyran compounds that provide such a combination of a significant or high level of darkness when exposed to actinic radiation, and a fast fade rate in the absence of actinic radiation, typically and undesirably have a bleached state (or color) that is too dark, and/or poor fatigue resistance.

It would be desirable to develop new indenonaphthopyran compounds that provide a combination of a significant or high level of darkness when exposed to actinic radiation, and a fast fade rate in the absence of actinic radiation, without a bleached state (or bleached color) that is too dark, and/or poor fatigue resistance.

### SUMMARY

In accordance with the present invention, there is provided an indenonaphthopyran compound represented by the following Formula (I),

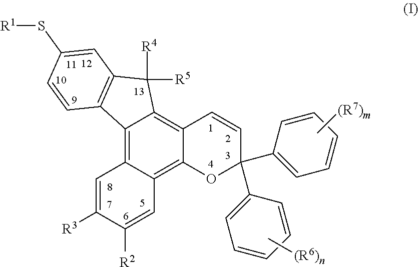

With reference to Formula (I): m is from 0 to 3; n is from 0 to 3; R¹ is aryl substituted with at least one perfluoroalkyl group, or heteroaryl substituted with at least one perfluoroalkyl group; R² is alkoxy; and R³ is alkoxy, amino, or substituted or unsubstituted nitrogen-containing heterocycle, provided that when R³ is other than alkoxy, R³ is covalently bonded to position-7 by a nitrogen atom. With further reference to Formula (I), R⁴ and R⁵ are each independently selected from: substituted or unsubstituted alkyl; or R⁴ and R⁵ together form a substituted or unsubstituted spirocyclic ring. With additional reference to Formula (I), R⁶ independently for each n, and R⁷ independently for each m, in each case are independently selected from: amino; substituted or unsubstituted nitrogen-containing heterocycle; a halo group; substituted or unsubstituted alkyl; substituted or unsubstituted alkoxy; perfluoroalkyl; or substituted or unsubstituted alkylthio.

There is also provided, in accordance with the present invention, a photochromic composition comprising the indenonaphthopyran compound of the present invention.

There is further provided, in accordance with the present invention, a photochromic article that comprises the indenonaphthopyran compound of the present invention.

The features that characterize the present invention are pointed out with particularity in the claims, which are annexed to and form a part of this disclosure. These and other features of the invention, its operating advantages and the specific objects obtained by its use will be more fully understood from the following detailed description in which non-limiting embodiments of the invention are illustrated and described.

### DETAILED DESCRIPTION

As used herein, the articles “a,” “an,” and “the” include plural referents unless otherwise expressly and unequivocally limited to one referent.

Unless otherwise indicated, all ranges or ratios disclosed herein are to be understood to encompass any and all subranges or subratios subsumed therein. For example, a stated range or ratio of “1 to 10” should be considered to include any and all subranges between (and inclusive of) the minimum value of 1 and the maximum value of 10; that is, all subranges or subratios beginning with a minimum value of 1 or more and ending with a maximum value of 10 or less, such as but not limited to, 1 to 6.1, 3.5 to 7.8, and 5.5 to 10.

As used herein, unless otherwise indicated, left-to-right representations of linking groups, such as divalent linking groups, are inclusive of other appropriate orientations, such as, but not limited to, right-to-left orientations. For purposes of non-limiting illustration, the left-to-right representation of the divalent linking group

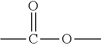

or equivalently —C(O)O—, is inclusive of the right-to-left representation thereof,

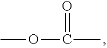

or equivalently —O(O)C— or —OC(O)—.

Other than in the operating examples, or where otherwise indicated, all numbers expressing quantities of ingredients, reaction conditions, and so forth used in the specification and claims are to be understood as modified in all instances by the term “about.”

As used herein, the term “polymer” means homopolymers (e.g., prepared from a single monomer species), copolymers (e.g., prepared from at least two monomer species), and graft polymers.

As used herein, the term “(meth)acrylate” and similar terms, such as “(meth)acrylic acid ester” means methacrylates and/or acrylates. As used herein, the term “(meth)acrylic acid” means methacrylic acid and/or acrylic acid.

The indenonaphthopyran compounds of the present invention are also referred to herein as photochromic indenonaphthopyran compounds and/or photochromic indenonaphthopyrans.

The indenonaphthopyran compounds of the present invention, as described herein, including, but not limited to, indenonaphthopyran compounds represented by Formula (I), can optionally further include one or more coproducts, resulting from the synthesis of such compounds.

As used herein, the term “photochromic” and similar terms, such as “photochromic compound” means having an absorption spectrum for at least visible radiation that varies in response to absorption of at least actinic radiation. Further, as used herein the term “photochromic material” means any substance that is adapted to display photochromic properties (such as, adapted to have an absorption spectrum for at least visible radiation that varies in response to absorption of at least actinic radiation) and which includes at least one photochromic compound.

As used herein, the term “actinic radiation” means electromagnetic radiation that is capable of causing a response in a material, such as, but not limited to, transforming a photochromic material from one form or state to another as will be discussed in further detail herein.

As used herein, the term “photochromic material” includes thermally reversible photochromic materials and compounds and non-thermally reversible photochromic materials and compounds. The term “thermally reversible photochromic compounds/materials” as used herein means compounds/materials capable of converting from a first state, for example a “clear state,” to a second state, for example a “colored state,” in response to actinic radiation, and reverting back to the first state in response to thermal energy. The term “non-thermally reversible photochromic compounds/materials” as used herein means compounds/materials capable of converting from a first state, for example a “clear state,” to a second state, for example a “colored state,” in response to actinic radiation, and reverting back to the first state in response to actinic radiation of substantially the same wavelength(s) as the absorption(s) of the colored state (e.g., discontinuing exposure to such actinic radiation).

As used herein to modify the term “state,” the terms “first” and “second” are not intended to refer to any particular order or chronology, but instead refer to two different conditions or properties. For purposes of non-limiting illustration, the first state and the second state of a photochromic compound can differ with respect to at least one optical property, such as but not limited to the absorption of visible and/or UV radiation. Thus, according to various non-limiting embodiments disclosed herein, the photochromic compounds of the present invention can have a different absorption spectrum in each of the first and second state. For example, while not limiting herein, a photochromic compound of the present invention can be clear in the first state and colored in the second state. Alternatively, a photochromic compound of the present invention can have a first color in the first state and a second color in the second state.

As used herein the term “optical” means pertaining to or associated with light and/or vision. For example, according to various non-limiting embodiments disclosed herein, the optical article or element or device can be chosen from ophthalmic articles, elements and devices, display articles, elements and devices, windows, mirrors, and active and passive liquid crystal cell articles, elements and devices.

As used herein the term “ophthalmic” means pertaining to or associated with the eye and vision. Non-limiting examples of ophthalmic articles or elements include corrective and non-corrective lenses, including single vision or multi-vision lenses, which can be either segmented or non-segmented multi-vision lenses (such as, but not limited to, bifocal lenses, trifocal lenses and progressive lenses), as well as other elements used to correct, protect, or enhance (cosmetically or otherwise) vision, including without limitation, contact lenses, intra-ocular lenses, magnifying lenses, and protective lenses or visors.

As used herein the term “display” means the visible or machine-readable representation of information in words, numbers, symbols, designs or drawings. Non-limiting examples of display elements include screens, monitors, and security elements, such as security marks.

As used herein the term “window” means an aperture adapted to permit the transmission of radiation there-through. Non-limiting examples of windows include automotive and aircraft transparencies, windshields, filters, shutters, and optical switches.

As used herein the term “mirror” means a surface that specularly reflects a large fraction of incident light.

As used herein the term “liquid crystal cell” refers to a structure containing a liquid crystal material that is capable of being ordered. A non-limiting example of a liquid crystal cell element is a liquid crystal display.

As used herein, the term “Ring Position” and similar terms, such as “Position-X” or “position-X” means a particular position in the ring structure, such as the fused ring structure, of a chemical compound, such as the indenonaphthopyran compounds of the present invention, and which are depicted herein in accordance with some embodiments by numbers within the ring structures of representative chemical formulas, such as Formula (I).

All documents, such as but not limited to issued patents and patent applications, referred to herein, and unless otherwise indicated, are to be considered to be “incorporated by reference” in their entirety.

As used herein, recitations of “linear or branched” groups, such as linear or branched alkyl, are herein understood to include: a methylene group or a methyl group; groups that are linear, such as linear C₂-C₂₀ alkyl groups; and groups that are appropriately branched, such as branched C₃-C₂₀ alkyl groups.

The term “alkyl” as used herein means linear or branched C₁-C₂₅ alkyl. Linear or branched alkyl can include C₁-C₂₅ alkyl, such as C₁-C₂₀ alkyl, such as C₂-C₁₀ alkyl, such as C₁-C₁₂ alkyl, such as C₁-C₆ alkyl. Examples of alkyl groups from which the various alkyl groups of the present invention can be selected from, include, but are not limited to, those recited further herein.

The term “cycloalkyl” as used herein means groups that are appropriately cyclic, such as, but not limited to, C₃-C₁₂ cycloalkyl (including, but not limited to, cyclic C₃-C₁₀ alkyl, or cyclic C₅-C₇ alkyl) groups. Examples of cycloalkyl groups include, but are not limited to, those recited further herein. The term “cycloalkyl” as used herein also includes: bridged ring polycycloalkyl groups (or bridged ring polycyclic alkyl groups), such as, but not limited to, bicyclo[2.2.1]heptyl (or norbornyl) and bicyclo[2.2.2]octyl; and fused ring polycycloalkyl groups (or fused ring polycyclic alkyl groups), such as, but not limited to, octahydro-1H-indenyl, and decahydronaphthalenyl.

The term “heterocycloalkyl” as used herein means groups that are appropriately cyclic, such as, but not limited to, C₂-C₁₂ heterocycloalkyl groups, such as C₂-C₁₀ heterocycloalkyl groups, such as C₅-C₇ heterocycloalkyl groups, and which have at least one hetero atom in the cyclic ring, such as, but not limited to, O, S, N, P, and combinations thereof. Examples of heterocycloalkyl groups include, but are not limited to, imidazolyl, tetrahydrofuranyl, tetrahydropyranyl, piperidinyl, morpholinyl, and piperazinyl. The term “heterocycloalkyl” as used herein also includes: bridged ring polycyclic heterocycloalkyl groups, such as, but not limited to, 7-oxabicyclo[2.2.1]heptanyl; and fused ring polycyclic heterocycloalkyl groups, such as, but not limited to, octahydrocyclopenta[b]pyranyl, and octahydro-1H-isochromenyl.

The term “nitrogen-containing heterocycle” as used herein, such as with regard to R³, means a cyclic ring that includes at least one nitrogen atom in the ring, such as one or two nitrogen atoms, and optionally at least one additional heteroatom that is other than nitrogen, such as oxygen, and which with some embodiments is covalently bonded to another group, such as an indenonaphthopyran compound according to the present invention, through a nitrogen atom in the ring. Examples of nitrogen-containing heterocycles include, but are not limited to: cyclic aminos, such as piperidino, pyrrolidino, piperazino, and morpholino; cyclic amides (or lactams), such as C₃-C₆ cyclic amides, such as β-propiolactam, γ-butyrolactam, δ-valerolactam, or ε-caprolactam; and heteroaromatics, such as imidazole, pyrrole, indole, and carbazole.

The descriptions, classes, and examples provided herein with regard to alkyl groups, cycloalkyl groups, heterocycloalkyl groups, haloalkyl groups, and the like, are also applicable to alkane groups, cycloalkane groups, heterocycloalkane groups, haloalkane groups, etc., such as, but not limited to, polyvalent alkane groups, such as polyvalent alkane linking groups, such as divalent alkane linking groups.

As used herein, the term “aryl” and related terms, such as “aryl group”, means an aromatic cyclic monovalent hydrocarbon radical. As used herein, the term “aromatic” and related terms, such as “aromatic group,” means a cyclic conjugated hydrocarbon having stability (due to delocalization of pi-electrons) that is significantly greater than that of a hypothetical localized structure. Examples of aryl groups include C₆-C₁₄ aryl groups, such as, but not limited to, phenyl, naphthyl, phenanthryl, and anthracenyl.

The term “heteroaryl”, as used herein, includes, but is not limited to, C₃-C₁₈ heteroaryl, such as, but not limited to, C₃-C₁₀ heteroaryl (including fused ring polycyclic heteroaryl groups) and means an aryl group having at least one hetero atom in the aromatic ring, or in at least one aromatic ring in the case of a fused ring polycyclic heteroaryl group. Examples of heteroaryl groups include, but are not limited to, furanyl, pyranyl, pyridinyl, quinolinyl, isoquinolinyl, and pyrimidinyl.

Representative alkyl groups include, but are not limited to, methyl, ethyl, propyl, isopropyl, butyl, isobutyl, sec-butyl, tert-butyl, pentyl, neopentyl, hexyl, heptyl, octyl, nonyl and decyl. Representative alkenyl groups include, but are not limited to, vinyl, allyl, and propenyl. Representative alkynyl groups include, but are not limited to, ethynyl, 1-propynyl, 2-propynyl, 1-butynyl, and 2-butynyl. Representative cycloalkyl groups include, but are not limited to, cyclopropyl, cyclobutyl, cyclopentyl, cyclohexyl, cycloheptyl, and cyclooctyl.

As used herein, the term “halo” and related terms, such as “halo group,” “halo substituent,” “halogen group,” and “halogen substituent,” means a single bonded halogen group, such as —F, —Cl, —Br, and —I.

As used herein, recitations of “halo substituted” and related terms (such as, but not limited to, haloalkyl groups, haloalkenyl groups, haloalkynyl groups, haloaryl groups, and halo-heteroaryl groups) means a group in which at least one, and up to and including all of the available hydrogen groups thereof is substituted with a halo group, such as, but not limited to F, Cl or Br. The term “halo-substituted” is inclusive of “perhalo-substituted.”

As used herein, recitations of “perfluoroalkyl group” means an alkyl group in which all available hydrogen groups thereof have in each case been substituted (or replaced) with a fluoro (F) group.

As used herein, “at least one of” is synonymous with “one or more of,” whether the elements are listed conjunctively or disjunctively. For example, the phrases “at least one of A, B, and C” and “at least one of A, B, or C” each mean any one of A, B, or C, or any combination of any two or more of A, B, or C. For example, A alone; or B alone; or C alone; or A and B; or A and C; or B and C; or all of A, B, and C.

As used herein, “selected from” is synonymous with “chosen from” whether the elements are listed conjunctively or disjunctively. Further, the phrases “selected from A, B, and C” and “selected from A, B, or C” each mean any one of A, B, or C, or any combination of any two or more of A, B, or C. For example, A alone; or B alone; or C alone; or A and B; or A and C; or B and C; or all of A, B, and C.

As used herein, and in accordance with some embodiments, the term “ketone” such as with regard to groups, and substituents of various groups, of the photochromic compounds of the present invention, and related terms, such as “ketone group” and “ketone substituent”, includes a material represented by —C(O)R, where R is selected from those groups as described below.

As used herein, and in accordance with some embodiments, the term “carboxylic acid” such as with regard to groups, and substituents of various groups, of the photochromic compounds of the present invention, and related terms, such as “carboxylic acid group” and “carboxylic acid substituent” includes a material represented by —C(O)OH.

As used herein, and in accordance with some embodiments, the term “ester” such as with regard to groups, and substituents of various groups, of the compounds and components of the present invention, and related terms, such as “ester group” and “ester substituent” means a carboxylic acid ester group represented by —C(O)OR, where R is selected from those groups as described below.

As used herein, and in accordance with some embodiments, the term “carbonate” such as with regard to groups, and substituents of various groups, of the compounds and components of the present invention, and related terms, such as “carbonate group” and “carbonate substituent” includes a material represented by —OC(O)OR, where R is selected from those groups as described below.

As used herein, and in accordance with some embodiments, the term “urethane,” such as with regard to groups, and substituents of various groups, of the compounds and components of the present invention, and related terms, such as “urethane group,” and “urethane substituent,” includes a material represented by —OC(O)N(R)(H) or —N(H)C(O)OR, where R in each case is independently selected from those groups as described below.

Unless otherwise stated, each R group of each of the above described ketone, ester (carboxylic acid ester), carbonate, and urethane groups, is in each case independently selected from alkyl, haloalkyl, perhaloalkyl, cycloalkyl, heterocycloalkyl, aryl, heteroaryl, and combinations thereof (including those classes and examples thereof as recited previously herein).

The indenonaphthopyran compounds according to the present invention, such as, but not limited to those represented by Formula (I), and the various groups thereof are described in further detail herein as follows.

As used herein, recitations of “substituted” group, with regard to the indenonaphthopyran compounds of the present invention, means a group including, but not limited to, alkyl group, heterocycloalkyl group, aryl group, and/or heteroaryl group, in which at least one hydrogen thereof has been replaced or substituted with a group that is other than hydrogen. The substituents of the “substituted” groups of the indenonaphthopyran compounds according to the present invention, with some embodiments, are in each case independently selected from: alkoxy groups; halo groups (e.g., F, Cl, I, and Br); hydroxyl groups; thiol groups; alkylthio groups; arylthio groups; ketone groups; aldehyde groups; ester groups; carboxylic acid groups; cyano groups; alkyl groups; alkenyl groups; alkynyl groups; haloalkyl groups; perhaloalkyl groups; cycloalkyl groups; heterocycloalkyl groups; aryl groups (including alkaryl groups, including hydroxyl substituted aryl, such as phenol, and including poly-fused-ring aryl); heteroaryl groups (including poly-fused-ring heteroaryl groups); amino groups, such as —N(R^{11′})(R^{12′}) where R^{11′} and R^{12′} are each independently selected from, for example, hydrogen, alkyl, heterocycloalkyl, aryl, or heteroaryl; carboxylate groups; amide groups; urethane groups; carbonate groups; urea groups; vinylphenyl groups; acrylate groups; methacrylate groups; acrylamide groups; methacrylamide groups; nitrogen-containing heterocycles; or combinations thereof, including those classes and examples as described further herein. With some further embodiments, the substituents of the “substituted” groups of the indenonaphthopyran compounds according to the present invention, are in each case independently selected from: alkoxy groups; halo groups (e.g., F, Cl, I, and Br); hydroxyl groups; thiol groups; ketone groups; aldehyde groups; ester groups; carboxylic acid groups; cyano groups; alkyl groups; haloalkyl groups; perhaloalkyl groups; cycloalkyl groups; heterocycloalkyl groups; aryl groups; and heteroaryl groups. In accordance with some embodiments of the present invention, the substituents of a substituted group are more particularly recited.

With reference to Formula (I): m is from 0 to 3 (such as, 0, 1, 2, or 3); and n is from 0 to 3 (such as, 0, 1, 2, or 3). With some embodiments of the present invention, at least one of m and n is at least 1. With some further embodiments of the present invention, m is 1 and/or n is 1. With some further embodiments of the present invention, m is 1, and n is 1.

With reference to Formula (I), and with some embodiments, R¹ is aryl substituted with at least one perfluoroalkyl group, or heteroaryl substituted with at least one perfluoroalkyl group. With some embodiments, R¹ is aryl substituted with at least one linear or branched C₁-C₁₀ perfluoroalkyl group, or heteroaryl substituted with at least one linear or branched C₁-C₁₀ perfluoroalkyl group.

In accordance with some embodiments of the present invention, and with reference to Formula (I), R² is alkoxy. As used herein, recitations of “R² is alkoxy,” and the like, means that the oxygen of the alkoxy group is bonded to Position-6 of the indenonaphthopyran represented by Formula (I). With some embodiments, R² is linear or branched C₁-C₁₀ alkoxy.

In accordance with some embodiments of the present invention, and with reference to Formula (I), R³ is alkoxy, amino, or substituted or unsubstituted nitrogen-containing heterocycle. When R³ is other than alkoxy (i.e., amino, or substituted or unsubstituted nitrogen-containing heterocycle), R³ is covalently bonded to position-7 by a nitrogen atom. As used herein, recitations of “R³ is alkoxy,” and the like, means that the oxygen of the alkoxy group is bonded to Position-7 of the indenonaphthopyran represented by Formula (I). With some embodiments, R³ is selected from amino, or substituted or unsubstituted nitrogen-containing heterocycle (and not selected from alkoxy).

With some embodiments, R³ of Formula (I) is selected from linear or branched C₁-C₁₀ alkoxy. With further reference to Formula (I), R³ is, with some embodiments, selected from secondary or tertiary amino represented by the following Formula (II),

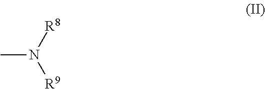

With reference to Formula (II), R⁸ and R⁹ are each independently selected from hydrogen, substituted or unsubstituted alkyl, substituted or unsubstituted cycloalkyl, or substituted or unsubstituted aryl, provided that at least one of R⁸ and R⁹ is other than hydrogen.

With additional reference to Formula (I), R³ is, with some embodiments, a nitrogen-containing hetrocycle selected from: substituted or unsubstituted piperidino (where the ring nitrogen thereof is covalently bonded to Position-7); substituted or unsubstituted morpholino (where the ring nitrogen thereof is covalently bonded to Position-7); and substituted or unsubstituted C₃-C₆ cyclic amide (where the ring/amide nitrogen thereof is covalently bonded to Position-7).

The R³ group of Formula (I), with some embodiments, is selected from a substituted or unsubstituted piperazino represented by the following Formula (III),

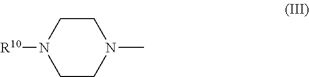

With reference to Formula (III), R¹⁰ is selected from hydrogen, substituted or unsubstituted alkyl, substituted or unsubstituted cycloalkyl, substituted or unsubstituted aryl, alkyl sulfonyl, or perhaloalkyl sulfonyl.

With reference to Formula (I), R⁴ and R⁵ are each independently selected from: substituted or unsubstituted alkyl; or R⁴ and R⁵ together form a substituted or unsubstituted spirocyclic ring. With some further embodiments, R⁴ and R⁵ together form a spirocyclic ring that is fully carbocyclic (containing only carbon atoms in the spirocyclic ring), such as a C₃-C₁₀ spirocyclic ring, or a C₅-C₈ spirocyclic ring. With some additional embodiments, R⁴ and R⁵ together form an unsubstituted spirocyclic ring. With some embodiments, R⁴ and R⁵ are each independently selected from unsubstituted linear or branched C₁-C₆ alkyl.

With reference to Formula (I), and in accordance with some embodiments, R⁶ independently for each n, and R⁷ independently for each m, in each case are independently selected from: amino; substituted or unsubstituted nitrogen-containing heterocycle; a halo group; substituted or unsubstituted alkyl; substituted or unsubstituted alkoxy; perfluoroalkyl; or substituted or unsubstituted alkylthio. With some further embodiments, R⁶ independently for each n, and R⁷ independently for each m, in each case are independently selected from: substituted or unsubstituted piperidino; substituted or unsubstituted morpholino; substituted or unsubstituted piperazino independently as described with reference to Formula (III) above and further herein; fluoro, chloro, or bromo; substituted or unsubstituted linear or branched C₁-C₁₈ alkyl; substituted or unsubstituted linear or branched C₁-C₆ alkyl; substituted or unsubstituted linear or branched C₁-C₁₈ alkoxy; or substituted or unsubstituted linear or branched C₁-C₆ alkoxy.

In accordance with some embodiments of the present invention and with reference to Formula (I), R¹ is phenyl substituted with at least one linear or branched C₁-C₄ perfluoroalkyl group, pyrdinyl substituted with at least one linear or branched C₁-C₄ perfluoroalkyl group, or pyrimidinyl substituted with at least one linear or branched C₁-C₄ perfluoroalkyl group. With some embodiments, R² of Formula (I) is linear or branched C₁-C₄ alkoxy.

With reference to Formula (I), and in accordance with some embodiments, R³ is selected from, linear or branched C₁-C₆ alkoxy. With some additional embodiments, R³ is selected from a secondary or tertiary amino represented by Formula (II), where for Formula (II), R⁸ and R⁹ are each independently selected from hydrogen, substituted or unsubstituted linear or branched C₁-C₆ alkyl, substituted or unsubstituted C₅-C₇ cycloalkyl, or substituted or unsubstituted aryl, provided that at least one of R⁸ and R⁹ is other than hydrogen. With some further embodiments, R³ is selected from: unsubstituted piperidino; substituted or unsubstituted morpholino; or unsubstituted C₃-C₆ cyclic amide. Additionally, and in accordance with some embodiments, R³ is selected from substituted or unsubstituted piperazino represented by Formula (III), wherein for Formula (III): R¹⁰ is selected from hydrogen; substituted or unsubstituted linear or branched C₁-C₆ alkyl; substituted or unsubstituted phenyl; or linear or branched C₁-C₆ perhaloalkyl sulfonyl.

In accordance with some embodiments, and with reference to Formula (I), R³ is selected from: linear or branched C₁-C₄ alkoxy; substituted or unsubstituted piperidino; substituted or unsubstituted morpholino; or unsubstituted C₃-C₆ cyclic amide. With some additional embodiments, R³ is selected from, secondary or tertiary amino represented by Formula (II), where for Formula (II), R⁸ and R⁹ are each independently selected from unsubstituted linear or branched C₁-C₄ alkyl, or linear or branched C₁-C₄ perhaloalkyl, provided that at least one of R⁸ and R⁹ is linear or branched C₁-C₄ perhaloalkyl. With some additional embodiments, R³ is selected from, a substituted piperazino represented by Formula (III), where for Formula (III), R¹⁰ is selected from substituted or unsubstituted linear or branched C₁-C₄ alkyl, substituted or unsubstituted phenyl, or linear or branched C₁-C₄ perhaloalkyl sulfonyl.

With reference to Formula (I), and with some embodiments, R⁴ and R⁵ are each independently selected from unsubstituted linear or branched C₁-C₄ alkyl.

In accordance with some embodiments, and with reference to Formula (I), R⁶ independently for each n, and R⁷ independently for each m, in each case are independently selected from: unsubstituted piperidino; unsubstituted morpholino; fluoro, chloro, or bromo; unsubstituted linear or branched C₁-C₄ alkyl; or unsubstituted linear or branched C₁-C₄ alkoxy.

With reference to Formula (I), and in accordance with some embodiments, at least one of R⁶ and R⁷ is unsubstituted linear or branched C₁-C₁₈ alkoxy, or unsubstituted linear or branched C₁-C₆ alkoxy, or unsubstituted linear or branched C₁-C₄ alkoxy.

In accordance with some embodiments of the indenonaphthopyran compounds of the present invention, and with reference to Formula (I), R¹ is selected from: 4-(trifluoromethyl)phenyl; 2-(trifluoromethyl)phenyl; 2,4-bis(trifluoromethyl)phenyl; 3,5-bis(trifluoromethyl)phenyl; 3,4-bis(trifluoromethyl)phenyl; or 5-(trifluoromethyl)pyridine-2-yl. In accordance with some further embodiments of the indenonaphthopyran compounds of the present invention, and with reference to Formula (I), R² is selected from, methoxy, ethoxy, n-propoxy, iso-propoxy, n-butoxy, or branched butoxy, such as t-butoxy; and R³ is selected from, morpholino, 2,6-dimethylmorpholino, 4-phenylpiperazino, 4-(trifluoromethyl)sulfonyl piperazino, γ-butyrolactam, 6-valerolactam, or F-caprolactam. In accordance with some additional embodiments of the indenonaphthopyran compounds of the present invention, and with reference to Formula (I): R⁴ and R⁵ are each independently selected from methyl, ethyl, n-propyl, iso-propyl, n-butyl, or branched butyl, such as t-butyl; and R⁶ and R⁷ are each independently selected from methoxy, ethoxy, n-propoxy, iso-propoxy, n-butoxy, or branched butoxy, such as t-butoxy.

In accordance with some embodiments of the indenonaphthopyran compounds of the present invention, and with reference to Formula (I), R¹ is selected from: 4-(trifluoromethyl)phenyl; 2-(trifluoromethyl)phenyl; 2,4-bis(trifluoromethyl)phenyl; 3,5-bis(trifluoromethyl)phenyl; 3,4-bis(trifluoromethyl)phenyl; or 5-(trifluoromethyl)pyridine-2-yl. In accordance with some further embodiments of the indenonaphthopyran compounds of the present invention, and with reference to Formula (I): R² is methoxy; and R³ is selected from, morpholino, 2,6-dimethylmorpholino, 4-phenylpiperazino, 4-(trifluoromethyl)sulfonyl piperazino, 7-butyrolactam, 6-valerolactam, or F-caprolactam. In accordance with some additional embodiments of the indenonaphthopyran compounds of the present invention, and with reference to Formula (I): R⁴ and R⁵ are each n-propyl; and R⁶ and R⁷ are each independently selected from methoxy or n-butoxy.

The indenonaphthopyran compounds according to the present invention can be prepared in accordance with art-recognized methods.

The indenonaphthopyran compound of the present invention is, with some embodiments, a photochromic indenonaphthopyran compound. In accordance with the present invention there is also provided a photochromic composition, which includes at least one indenonaphthopyran compound according to the present invention, which is a photochromic indenonaphthopyran compound, such as represented by Formula (I).

The photochromic indenonaphthopyran compounds of the present invention can be used in combination with a mixture of other photochromic compounds. For example, although not limiting herein, mixtures of photochromic compounds can be used to attain certain activated colors, such as a near neutral gray or near neutral brown. See, for example, U.S. Pat. No. 5,645,767, col. 12, line 66 to col. 13, line 19, which describes the parameters that define neutral gray and brown colors.

Examples of classes of other photochromic compounds that can be used in combination with the photochromic indenonaphthopyran compounds of the present invention, include, but are not limited to, indeno-fused naphthopyrans, naphtho[1,2-b]pyrans, naphtho[2,1-b]pyrans, spirofluoroeno[1,2-b]pyrans, phenanthrenopyrans, quinolinopyrans, fluoroanthenopyrans, spiropyrans, benzoxazines, naphthoxazines, spiro(indoline)naphthoxazines, spiro(indoline)pyridobenzoxazines, spiro(indoline)fluoranthenoxazines, spiro(indoline)quinoxazines, fulgides, fulgimides, diarylethenes, diarylalkylethenes, diarylalkenylethenes, thermally reversible photochromic compounds, and non-thermally reversible photochromic compounds, and mixtures thereof.

The photochromic compositions of the present invention can, with some embodiments, further include one or more fixed-tint dyes. As used herein, the term “fixed-tint dye” and related terms, such as “fixed-colorant,” “static colorant,” “fixed dye,” and “static dye” means dyes that are: non-photosensitive materials, which do not physically or chemically respond to electromagnetic radiation with regard to the visually observed color thereof. The term “fixed-tint dye” and related terms as used herein does not include and is distinguishable from photochromic compound. As used herein, the term “non-photosensitive materials” means materials that do not physically or chemically respond to electromagnetic radiation with regard to the visually observed color thereof, including, but not limited to, fixed-tint dyes.

One or more fixed-tint dyes can be present in the photochromic compositions of the present invention for purposes including, but not limited to, providing a article prepared from the photochromic compositions with: at least a base (or first) color characteristic of the fixed-tint dye, when the photochromic compound is not activated; and optionally a second color characteristic of the combination of the fixed-tint dye and the photochromic compound when activated, such as by exposure to actinic radiation.

The optional fixed-tint dye of the photochromic composition, with some embodiments, includes at least one of azo dyes, anthraquinone dyes, xanthene dyes, azime dyes, iodine, iodide salts, polyazo dyes, stilbene dyes, pyrazolone dyes, triphenylmethane dyes, quinoline dyes, oxazine dyes, thiazine dyes, and polyene dyes.

The fixed-tint dye can be present in the photochromic composition in varying amounts to provide the intended effect in the cured article prepared therefrom. With some embodiments, the fixed-tint dye is present in the photochromic composition in an amount of from 0.001 to 15 percent by weight, or from 0.01 to 10 percent by weight, or from 0.1 to 2.5 percent by weight, the percent weights in each case being based on the total resin solids weight of the photochromic composition.

In accordance with some embodiments of the present invention, the photochromic composition includes: (i) a matrix forming material, in which the matrix forming material is at least one of a polymeric material, an oligomeric material, and/or a monomeric material; and (ii) the indenonaphthopyran compound according to the present invention, which is a photochromic indenonaphthopyran compound, such as represented by Formula (I). The photochromic indenonaphthopyran compound can be incorporated into a portion of the organic material by methods including, but not limited to, at least one of blending or bonding the photochromic compound with the organic material or a precursor of the organic material. As used herein with reference to the incorporation of photochromic compounds into an organic material, the terms “blending” and “blended” mean that the photochromic compound/material is intermixed or intermingled with the at least a portion of the organic material, but not bonded to the organic material. Further, as used herein with reference to the incorporation of photochromic compounds into an organic material, the terms “bonding” or “bonded” mean that the photochromic compound/material is linked, such as by one or more covalent bonds, to a portion of the organic material or a precursor thereof. For example, although not limiting herein, the photochromic material can be linked to the organic material through a reactive substituent, such as, but not limited to a hydroxyl group, a primary amine group, and/or a secondary amine group.

When the organic material is a polymeric material, the photochromic compound can be incorporated into at least a portion of the polymeric material or at least a portion of the monomeric material or oligomeric material from which the polymeric material is formed. For example, photochromic compound(s) according to the present invention that have a reactive substituent can be bonded to an organic material such as a monomer, oligomer, or polymer having a group with which a reactive moiety may be reacted, or the reactive moiety can be reacted as a co-monomer in the polymerization reaction from which the organic material is formed, for example, in a co-polymerization process.

As discussed above, the photochromic compositions according to present invention can include an organic material chosen from a polymeric material, an oligomeric material and/or a monomeric material, with some embodiments. Examples of polymeric materials that can be used with the photochromic compositions of the present invention include, but are not limited to: poly(carbonate); copolymers of ethylene and vinyl acetate; copolymers of ethylene and vinyl alcohol; copolymers of ethylene, vinyl acetate, and vinyl alcohol (such as those that result from the partial saponification of copolymers of ethylene and vinyl acetate); cellulose acetate butyrate; poly(urethane); poly(acrylate); poly(methacrylate); epoxies; aminoplast functional polymers; poly(anhydride); poly(urea urethane); N-alkoxymethyl(meth)acrylamide functional polymers; poly(siloxane); poly(silane); and combinations and mixtures thereof. Further classes and examples of polymeric materials that can be used with the photochromic compositions of the present invention include, but are not limited to, those disclosed at column 39, line 45 through column 40, line 67 of U.S. Pat. No. 9,028,728 B2.

The photochromic composition of the present invention can include at least one of, a complementary photochromic material (including one or more of those other photochromic materials and compounds described previously herein), a photoinitiator, a thermal initiator, a polymerization inhibitor, a solvent, a light stabilizer, a heat stabilizer, a mold release agent, a rheology control agent, a leveling agent, a free radical scavenger, and/or an adhesion promoter.

The photochromic composition according to the present invention can be a photochromic coating composition. Photochromic coating compositions of the present invention can include: a photochromic compound according to the present invention, such as described previously herein with regard to Formula (I); a resin composition that is optionally curable; and optionally a solvent. The photochromic coating composition can be in the form of art-recognized liquid coatings and powder coatings. The photochromic coating compositions of the present invention can be thermoplastic or curable (e.g., thermosetting and/or photosetting) coating compositions.

The curable resin composition of the curable photochromic coating compositions according to the present invention can include: a first reactant (or component) having functional groups, e.g., an epoxide functional polymer reactant; and a second reactant (or component) that is a crosslinking agent having functional groups that are reactive towards and that can form covalent bonds with the functional groups of the first reactant. The first and second reactants of the curable resin composition of the curable photochromic coating composition can each independently include one or more functional species, and are each present in amounts sufficient to provide cured photochromic coatings having a desirable combination of physical properties, e.g., smoothness, optical clarity, solvent resistance, and hardness.

Examples of curable resin compositions that can be used with the curable photochromic coating compositions according to the present invention include, but are not limited to: curable resin compositions including epoxide functional polymer (e.g., (meth)acrylic polymers containing residues of glycidyl (meth)acrylate) and epoxide reactive crosslinking agent (e.g., containing active hydrogens, such as hydroxyls, thiols and amines); and curable resin compositions including active hydrogen functional polymer (e.g., hydroxy, thiol, and/or amine functional polymer) and capped (or blocked) isocyanate functional crosslinking agent. By “capped (or blocked) isocyanate functional crosslinking agent” is meant a crosslinking agent having two or more capped isocyanate groups that can decap (or deblock) under cure conditions (e.g., at elevated temperature) to form free isocyanate groups and free capping groups. The free isocyanate groups formed by decapping of the crosslinking agent are preferably capable of reacting and forming substantially permanent covalent bonds with the active hydrogen groups of the active hydrogen functional polymer (e.g., with the hydroxy groups of a hydroxy functional polymer). Further examples of curable resin compositions that can be used with the curable photochromic coating compositions according to the present invention include, but are not limited to, those disclosed in: paragraphs [0176] through [0190] of WO 2016/142496 A1; and paragraphs [0005], [0037] through [0051], [0056] through [0059], and [0063] through [0065] of WO 2017/030545 A1.

Curable photochromic coating compositions according to the present invention can, optionally, contain additives such as waxes for flow and wetting, flow control agents, e.g., poly(2-ethylhexyl)acrylate, adjuvant resin to modify and optimize coating properties, antioxidants and ultraviolet (UV) light absorbers. Examples of useful antioxidants and UV light absorbers include those available commercially from BASF under the trademarks IRGANOX and TINUVIN. These optional additives, when used, are typically present in amounts up to 20 percent by weight (e.g., from 0.5 to 10 percent by weight), based on total weight of resin solids of the curable resin composition.

Photochromic compositions, photochromic articles and photochromic coating compositions according to the present invention can further include art-recognized additives that aid or assist in the processing and/or performance of the compositions or articles. Non-limiting examples of such additives include photoinitiators, thermal initiators, polymerization inhibitors, solvents, light stabilizers (such as, but not limited to, ultraviolet light absorbers and light stabilizers, such as hindered amine light stabilizers (HALS)), heat stabilizers, mold release agents, rheology control agents, leveling agents (such as, but not limited to, surfactants), free radical scavengers, adhesion promoters (such as hexanediol diacrylate and coupling agents), and combinations and mixtures thereof.

The photochromic compositions of the present invention can, with some embodiments, include one or more solvents, such as one or more organic solvents.

Classes of organic solvents that can be present in the photochromic compositions of the present invention include, but are not limited to: ketones, such as, acetone, methyl ethyl ketone, and methyl isobutyl ketone; ethers, such as, dimethyl ether and methyl ethyl ether; cyclic ethers, such as, tetrahydrofuran and dioxane; esters, such as, ethyl acetate, ethyl lactate, ethylene carbonate and propylene carbonate; nitrogen containing cyclic compounds, such as, pyrrolidone, N-methyl-2-pyrrolidone, 1-butyl-pyrrolidinone, and 1,3-dimethyl-2-imidazolidinone; sulfur containing compounds, such as, dimethyl sulfoxide and tetramethylene sulfone; aromatic compounds, such as, toluene, xylene, anisole, and butyl benzoate; and mixtures of aromatic compounds, such as, but not limited to, Aromatic 100 Fluid, which is a commercially available mixture of C₉-C₁₀ dialkyl- and trialkyl-benzenes, and Aromatic 150 Fluid, which is a commercially available mixture of C₁₀-C₁₂ alkylbenzenes and alkylnaphthalenes.

Solvent(s) can be present in the photochromic compositions of the present invention, in an amount of from 5 to 95 percent by weight, or from 15 to 80 percent by weight, from 30 to 70 percent by weight, or from 30 to 60 percent by weight, in each case based on the total weight of the photochromic composition (including the weight of the solvent).

The photochromic compounds of the present invention can be used in amounts (or ratios) such that the compositions, organic material or substrate (e.g., photochromic articles and photochromic coatings) into which the photochromic compounds are incorporated or otherwise connected exhibits desired optical properties. The amount and types of photochromic material can be selected such that the composition, organic material or substrate is clear or colorless when the photochromic compound is in the closed-form (e.g., in the bleached or unactivated state), and can exhibit a desired resultant color when the photochromic compound (such as a photochromic indeno-fused naphthopyran of the present invention) is in the open-form (e.g., when activated by actinic radiation). The precise amount of the photochromic material that is utilized in the various photochromic compositions and articles described herein is not critical provided that a sufficient amount is used to produce the desired effect. The particular amount of the photochromic material used can depend on a variety of factors, such as but not limited to, the absorption characteristics of the photochromic compound, the color and intensity of the color desired upon activation, and the method used to incorporate or connect the photochromic material to the substrate. Photochromic compositions according to the present invention can include the photochromic compound according to the present invention, including the compounds represented by Formula (I) in an amount of from 0.01 to 40 weight percent, such as from 0.05 to 15 weight percent, such as from 0.1 to 5 weight percent, based on the weight of the photochromic composition. For purposes of further non-limiting illustration, the amount of the photochromic compound/material including the compound(s) represented by Formula (I), that is incorporated into an organic material can range from 0.01 to 40 weight percent, such as from 0.05 to 15 weight percent, such as from 0.1 to 5 weight percent, based on the weight of the organic material.

The present invention also relates to photochromic articles that include one or more photochromic compounds according to the present invention, such as represented by Formula (I). The photochromic articles can be prepared by art-recognized methods, such as, but not limited to, by imbibition methods, cast-in-place methods, coating methods, in-mold coating methods, over-mold methods, and lamination methods.

For example, the photochromic articles can be selected from ophthalmic articles, display articles, windows, mirrors, active liquid crystal cell articles, and passive liquid crystal cell articles.

The photochromic articles of the present invention, with some embodiments, can be ophthalmic articles, and the ophthalmic articles can be selected from corrective lenses, non-corrective lenses, contact lenses, intra-ocular lenses, magnifying lenses, protective lenses, and visors.

The photochromic articles of the present invention can, with some further embodiments, be display articles, and the display articles can be selected from screens, monitors, and security elements.

The present invention can be further characterized by one or more of the following non-limiting aspects.

Aspect 1: An indenonaphthopyran compound represented by the following Formula (I),

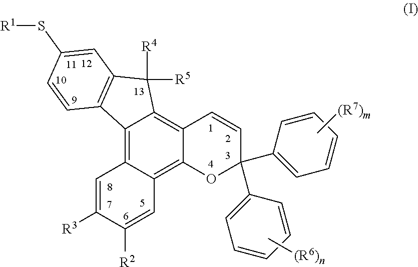

wherein,
   m is from 0 to 3;
   n is from 0 to 3;
   R¹ is aryl substituted with at least one perfluoroalkyl group, or heteroaryl substituted with at least one perfluoroalkyl group;
   R² is alkoxy;
   R³ is alkoxy, amino, or substituted or unsubstituted nitrogen-containing heterocycle, wherein when R³ is other than alkoxy, R³ is covalently bonded to position-7 by a nitrogen atom;
   R⁴ and R⁵ are each independently selected from, substituted or unsubstituted alkyl; or
      R⁴ and R⁵ together form a substituted or unsubstituted spirocyclic ring; and
   R⁶ independently for each n, and R⁷ independently for each m, in each case are independently selected from,
   amino;
   substituted or unsubstituted nitrogen-containing heterocycle;
   a halo group;
   substituted or unsubstituted alkyl;
   substituted or unsubstituted alkoxy;
   perfluoroalkyl; or
   substituted or unsubstituted alkylthio.

Aspect 2: The indenonaphthopyran compound of aspect 1 wherein,
R¹ is aryl substituted with at least one linear or branched C₁-C₁₀ perfluoroalkyl group, or heteroaryl substituted with at least one linear or branched C₁-C₁₀ perfluoroalkyl group;
R² is linear or branched C₁-C₁₀ alkoxy;
R³ is selected from,
   linear or branched C₁-C₁₀ alkoxy,
   secondary or tertiary amino represented by the following Formula (II),

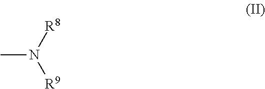

wherein for Formula (II), R⁸ and R⁹ are each independently selected from hydrogen, substituted or unsubstituted alkyl, substituted or unsubstituted cycloalkyl, or substituted or unsubstituted aryl, provided that at least one of R⁸ and R⁹ is other than hydrogen,
substituted or unsubstituted piperidino,
substituted or unsubstituted morpholino,
substituted or unsubstituted C₃-C₆ cyclic amide, or
substituted or unsubstituted piperazino represented by the following Formula (III),

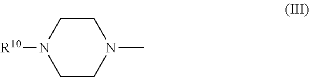

wherein for Formula (III),
   R¹⁰ is selected from hydrogen, substituted or unsubstituted alkyl, substituted or unsubstituted cycloalkyl, substituted or unsubstituted aryl, alkyl sulfonyl, or perhaloalkyl sulfonyl.

Aspect 3: The indenonaphthopyran compound of aspect 2 wherein,
R¹ is aryl substituted with at least one linear or branched C₁-C₆ perfluoroalkyl group, or heteroaryl substituted with at least one linear or branched C₁-C₆ perfluoroalkyl group;
R² is linear or branched C₁-C₆ alkoxy;
R³ is selected from,
   linear or branched C₁-C₆ alkoxy,
   secondary or tertiary amino represented by Formula (II),
      wherein for Formula (II), R⁸ and R⁹ are each independently selected from hydrogen, substituted or unsubstituted linear or branched C₁-C₆ alkyl, substituted or unsubstituted C₅-C₇ cycloalkyl, or substituted or unsubstituted aryl, provided that at least one of R⁸ and R⁹ is other than hydrogen,
   unsubstituted piperidino,
   substituted or unsubstituted morpholino,
   unsubstituted C₃-C₆ cyclic amide, or
   substituted or unsubstituted piperazino represented by Formula (III),
      wherein for Formula (III),
         R¹⁰ is selected from hydrogen, substituted or unsubstituted linear or branched C₁-C₆ alkyl, substituted or unsubstituted phenyl, or linear or branched C₁-C₆ perhaloalkyl sulfonyl,
R⁴ and R⁵ are each independently selected from,
   unsubstituted linear or branched C₁-C₆ alkyl; and
R⁶ independently for each n, and R⁷ independently for each m, in each case are independently selected from,
substituted or unsubstituted piperidino,
substituted or unsubstituted morpholino,
substituted or unsubstituted piperazino independently as described with reference to Formula (III),
fluoro, chloro, or bromo,
substituted or unsubstituted linear or branched C₁-C₆ alkyl, or substituted or unsubstituted linear or branched C₁-C₆ alkoxy.

Aspect 4: The indenonaphthopyran compound of aspect 2 or aspect 3 wherein,
R¹ is phenyl substituted with at least one linear or branched C₁-C₄ perfluoroalkyl group, or pyridinyl substituted with at least one linear or branched C₁-C₄ perfluoroalkyl group;
R² is linear or branched C₁-C₄ alkoxy;
R³ is selected from,
   linear or branched C₁-C₄ alkoxy,
   secondary or tertiary amino represented by Formula (II),
      wherein for Formula (II), R⁸ and R⁹ are each independently selected from unsubstituted linear or branched C₁-C₄ alkyl, or linear or branched C₁-C₄ perhaloalkyl, provided that at least one of R⁸ and R⁹ is linear or branched C₁-C₄ perhaloalkyl,
   substituted or unsubstituted piperidino,
   substituted or unsubstituted morpholino,
   substituted piperazino represented by Formula (III),
      wherein for Formula (III),
         R¹⁰ is selected from substituted or unsubstituted linear or branched C₁-C₄ alkyl, substituted or unsubstituted phenyl, or linear or branched C₁-C₄ perhaloalkyl sulfonyl, or
   unsubstituted C₃-C₆ cyclic amide;
R⁴ and R⁵ are each independently selected from, unsubstituted linear or branched C₁-C₄ alkyl; and
R⁶ independently for each n, and R⁷ independently for each m, in each case are independently selected from,
unsubstituted piperidino,
unsubstituted morpholino,
fluoro, chloro, or bromo,
unsubstituted linear or branched C₁-C₄ alkyl, or
unsubstituted linear or branched C₁-C₄ alkoxy.

Aspect 5: The indenonaphthopyran compound of any one of aspects 1 to 4, provided that at least one of R⁶ and R⁷ is unsubstituted linear or branched C₁-C₄ alkoxy.

Aspect 6: The indenonaphthopyran compound of any one of aspects 1 to 5, wherein,
R¹ is selected from,
   4-(trifluoromethyl)phenyl,
   2-(trifluoromethyl)phenyl,
   2,4-bis(trifluoromethyl)phenyl,
   3,5-bis(trifluoromethyl)phenyl,
   3,4-bis(trifluoromethyl)phenyl, or
   5-(trifluoromethyl)pyridine-2-yl;
R² is selected from,
   methoxy, or
   ethoxy,
R³ is selected from,
   morpholino,
   2,6-dimethylmorpholino,
   4-phenylpiperazino,
   4-(trifluoromethyl)sulfonyl piperazino,
   γ-butyrolactam,
   δ-valerolactam, or
   ε-caprolactam;
R⁴ and R⁵ are each independently selected from,
   methyl,
   ethyl,
   n-propyl,
   iso-propyl,
   n-butyl, or
   branched butyl, such as t-butyl; and
R⁶ and R⁷ are each independently selected from,
   methoxy,
   ethoxy,
   n-propoxy,
   iso-propoxy,
   n-butoxy, or
   branched butoxy, such as t-butoxy.

Aspect 7: The indenonaphthopyran compound of any one of aspects 1 to 6, wherein,
R¹ is selected from,
   4-(trifluoromethyl)phenyl,
   2-(trifluoromethyl)phenyl,
   2,4-bis(trifluoromethyl)phenyl,
   3,5-bis(trifluoromethyl)phenyl,
   3,4-bis(trifluoromethyl)phenyl, or
   5-(trifluoromethyl)pyridine-2-yl;
R² is methoxy;
R³ is selected from,
   morpholino,
   2,6-dimethylmorpholino,
   4-phenylpiperazino,
   4-(trifluoromethyl)sulfonyl piperazino,
   γ-butyrolactam,
   δ-valerolactam, or
   ε-caprolactam;
R⁴ and R⁵ are each n-propyl; and
R⁶ and R⁷ are each independently selected from methoxy or n-butoxy.

Aspect 8: A photochromic composition comprising the indenonaphthopyran compound of any one of aspects 1 to 7.

Aspect 9: A photochromic article comprising the indenonaphthopyran compound of any one of aspects 1 to 7, wherein the photochromic article is selected from the group consisting of ophthalmic articles, display articles, windows, mirrors, active liquid crystal cell articles, and passive liquid crystal cell articles.

Aspect 10: The photochromic article of aspect 9, wherein the photochromic article is selected from ophthalmic articles, and the ophthalmic articles are selected from corrective lenses, non-corrective lenses, contact lenses, intra-ocular lenses, magnifying lenses, protective lenses, and visors.

The present invention is more particularly described in the following examples, which are intended as illustrative only, since numerous modifications and variations therein will be apparent to those skilled in the art.

### EXAMPLES

In Part-1 of the following examples there are provided descriptions of the synthetic preparation of comparative indenonaphthopyran compounds (Comparative Examples/Compounds CE1, CE2, CE12, and CE13) and indenonaphthopyran compounds according to the present invention (Examples/Compounds 3-11, 14, and 15). In Part-2 there is provided a summary of an evaluation of the comparative and inventive indenonaphthopyran compounds of Part-1.

### Part-1

### Synthetic Descriptions

The following Scheme-1 provides a summary, in particular, of the synthesis of the indenonaphthopyran compound of Comparative Example 1 (CE1). Scheme-1 also includes starting materials, and/or intermediates, and/or alternative species thereof that were used to synthesize other comparative and inventive compounds in the following examples.

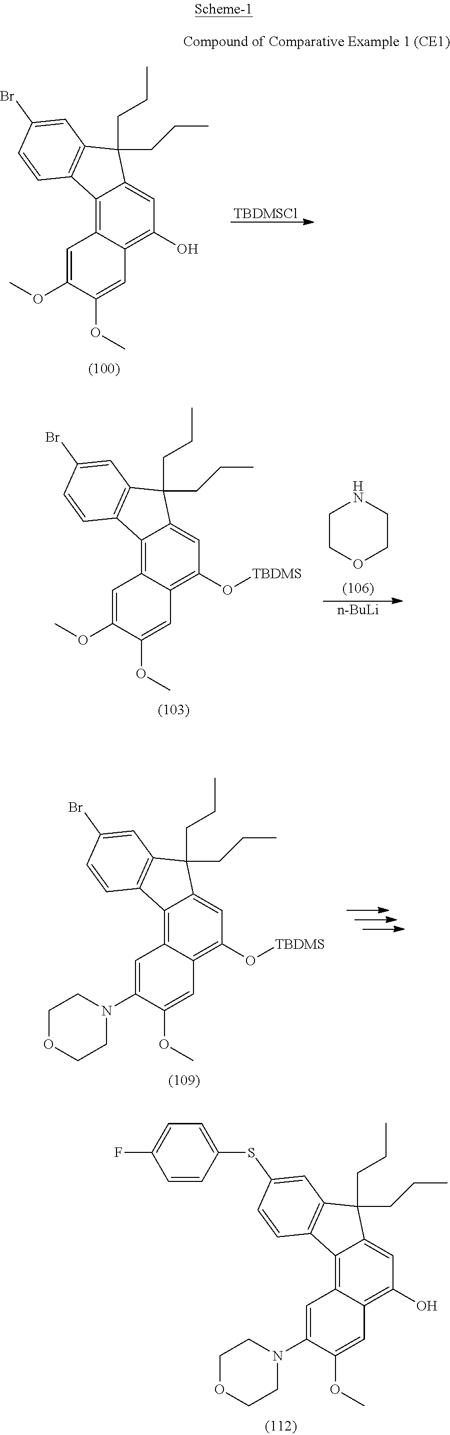

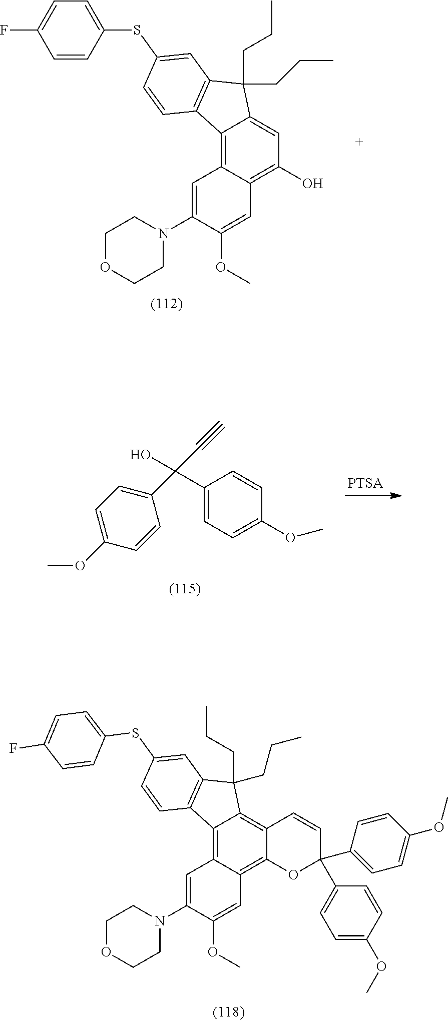

### Comparative Example CE1

A comparative compound, CE1, was prepared in accordance with the following steps.

### Step 1:

In a round-bottom flask, 9-bromo-2,3-dimethoxy-7,7-dipropyl-7H-benzo[c]fluoren-5-ol (20 g) (100), imidazole (4.48 g), 4-(dimethylamino)pyridine (0.54 g), and anhydrous N,N-dimethylformamide (60 mL) were combined and stirred. The mixture was cooled to between −5 and 0° C. by submersing the flask in a brine and ice bath. Tert-butyldimethylsilyl chloride (7.94 g) (TBDMSCI) was then added to the reaction mixture in four equal portions spaced 5 minutes apart. The reaction mixture was allowed to warm to room temperature and then stirred for 16 hours. It was then poured into ice water and extracted twice with ethyl acetate. The combined organic layers were washed with brine twice, dried over sodium sulfate, and concentrated to dryness. The resulting residue was filtered over a short plug of silica gel and the filter was washed with a mixture of 25% ethyl acetate and 75% hexanes. The mother liquor was concentrated to dryness resulting in an amber colored oil consistent with the intermediate product (103′) depicted below, and (103) in Scheme-1 (25.02 g).

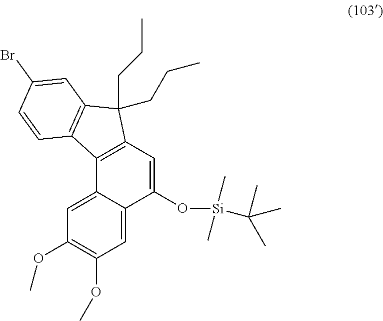 [SMILES: CCCC1(CCC)c2cc(Br)ccc2-c2c1cc(O[Si](C)(C)C(C)(C)C)c1cc(OC)c(OC)cc21]

### Step 2:

Hexanes (55 mL) and morpholine (3.87 g) (106) were combined in a 2-neck round-bottom flask. The flask was submerged in an ice bath and then a 2.5 M solution of n-butyllithium (n-BuLi) in hexanes (15.4 mL) was added dropwise via syringe over 5 minutes. The intermediate product (103) from Step 1 (11.00 g) was then added to the mixture, followed by anhydrous tetrahydrofuran (70 mL). The reaction mixture was warmed to room temperature for 1 hour and then poured into ice water. It was extracted twice with ethyl acetate and then the combined organic layers were washed with brine, dried over sodium sulfate, and concentrated to dryness. The resulting residue was filtered over a short plug of silica gel and the filter was washed with a mixture of 25% ethyl acetate and 75% hexanes. The mother liquor was concentrated to dryness resulting in an amber colored oil consistent with the intermediate product below (9.23 g) (109′), and (109) of Scheme-1.

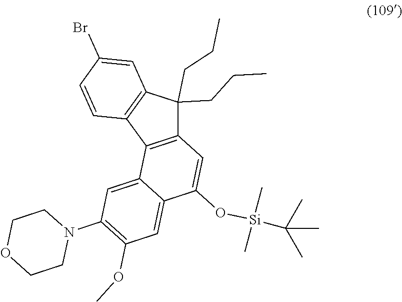 [SMILES: CCCC1(CCC)c2cc(Br)ccc2-c2c1cc(O[Si](C)(C)C(C)(C)C)c1cc(OC)c(N3CCOCC3)cc21]

### Step 3:

The intermediate product from Step 2 (4.62 g) (109′), isooctyl 3-mercaptopropionate (1.78 g), N,N-diisopropylethylamine (1.91 g), and toluene (28 mL) were combined and stirred in a round-bottom flask. The mixture was purged with nitrogen gas for 20 minutes. Tris(dibenzylideneacetone)dipalladium(0) (0.20 g) and 4,5-bis(diphenylphosphino)-9,9-dimethylxanthene (0.26 g) were added to the mixture. It was heated to 110° C. for 90 minutes and then cooled to room temperature. Anhydrous N,N-dimethylformamide (26 mL) followed by a 40% solution of sodium tert-pentoxide in toluene (8.13 g) were charged to the reaction mixture and stirred for 10 minutes. Next was added 1-bromo-4-fluorobenzene (5.17 g), followed by heating the mixture to 120° C. for 1 hour. After cooling to room temperature, the reaction mixture was poured into ice water and then a dilute aqueous solution of hydrochloric acid was added until a pH of 5 was obtained. It was then extracted twice with ethyl acetate. The combined organic layers were washed with brine twice, dried over sodium sulfate, and then concentrated to dryness. The resulting residue was purified using flash chromatography on silica gel and eluting with a mixture of 25% ethyl acetate and 75% hexanes. Fractions containing the desired intermediate product were combined and concentrated to dryness. The resulting solid was slurried in a mixture of 10% ethyl acetate and 90% hexanes and then collected by vacuum filtration to give an intermediate product represented by the following structure (1.50 g) (112).

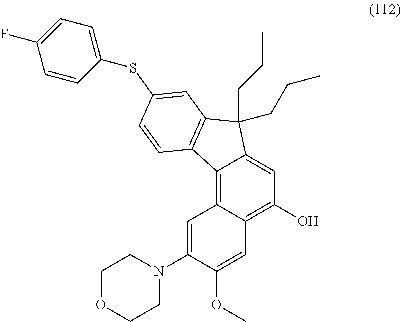 [SMILES: CCCC1(CCC)c2cc(Sc3ccc(F)cc3)ccc2-c2c1cc(O)c1cc(OC)c(N3CCOCC3)cc21]

### Step 4:

The intermediate product (112) from Step 3 (1.00 g), 1,1-bis(4-methoxyphenyl)prop-2-yn-1-ol (0.63 g) (115), 4-pyridinium p-toluenesulfonate (0.06 g) (PTSA) and 1,2-dichloroethane (20 mL) were combined in a round-bottom flask and heated to 83° C. for two hours. After cooling to room temperature, the reaction mixture was filtered over a short plug of silica gel and the filter was washed with a mixture of 25% ethyl acetate and 75% hexanes. The mother liquor was concentrated to dryness. The resulting residue was purified using flash chromatography on silica gel and eluting with a mixture of 25% ethyl acetate and 75% hexanes. Fractions containing desired product were combined and concentrated to dryness. Methanol was added to the resulting residue to precipitate a solid, which was then collected using vacuum filtration. NMR analysis of the solid is consistent with the following representative structure (0.97 g) (118).

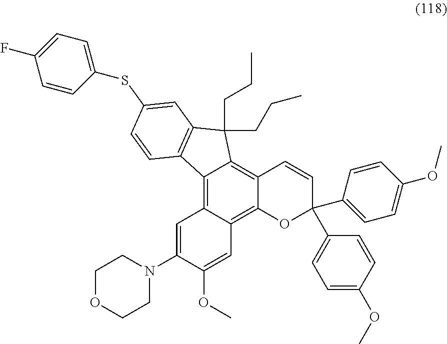 [SMILES: CCCC1(CCC)c2cc(Sc3ccc(F)cc3)ccc2-c2c1c1c(c3cc(OC)c(N4CCOCC4)cc23)OC(c2ccc(OC)cc2)(c2ccc(OC)cc2)C=C1]

### Compounds of Comparative Examples 2, 12, and 13 (CE2, CE12, and CE13), and Examples 3-11, 14, and 15

The compounds depicted in the following Table A were prepared generally in accordance with the synthetic procedure as described with regard to CE1, using: corresponding amine precursors in Step 2; appropriately substituted bromobenzene compounds in Step 3; and appropriately substituted propargyl alcohols in Step 4. The compounds of Comparative Examples CE13 and CE14, as well as Examples 15 and 16, were prepared generally in accordance with the synthetic procedure as described with regard to CE1, but in the absence of the amination in Step 2, so as to achieve the 6,7-dimethoxy substituted compounds (rather than 6-methoxy, 7-morpholino substituted compounds).

TABLE 1

| Representative Structure | Compound/Example No. |
|---|---|
| 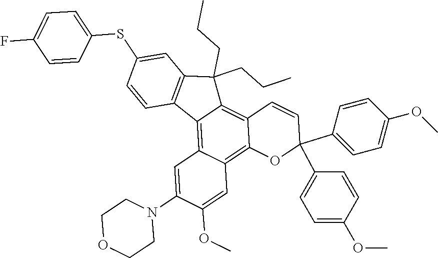 [SMILES: CCCC1(CCC)c2cc(Sc3ccc(F)cc3)ccc2-c2c1c1c(c3cc(OC)c(N4CCOCC4)cc23)OC(c2ccc(OC)cc2)(c2ccc(OC)cc2)C=C1] | CE1 |
| 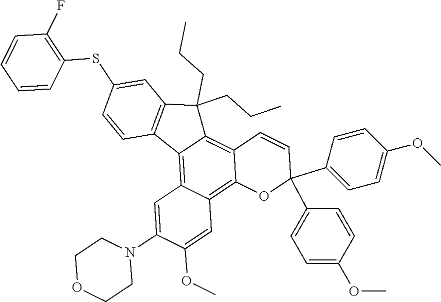 [SMILES: CCCC1(CCC)c2cc(Sc3ccccc3F)ccc2-c2c1c1c(c3cc(OC)c(N4CCOCC4)cc23)OC(c2ccc(OC)cc2)(c2ccc(OC)cc2)C=C1] | CE2 |
| 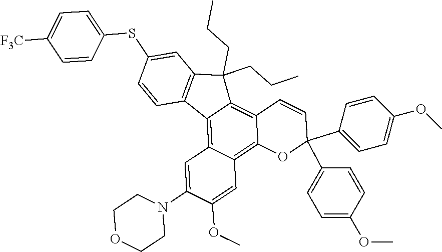 [SMILES: CCCC1(CCC)c2cc(Sc3ccc(C(F)(F)F)cc3)ccc2-c2c1c1c(c3cc(OC)c(N4CCOCC4)cc23)OC(c2ccc(OC)cc2)(c2ccc(OC)cc2)C=C1] | 3 |
| 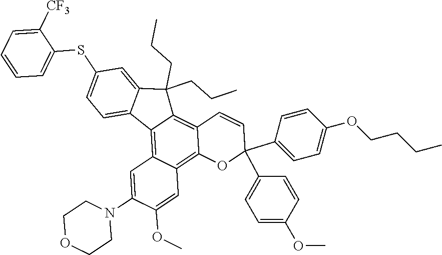 [SMILES: CCCCOc1ccc(C2(c3ccc(OC)cc3)C=Cc3c4c(c5cc(N6CCOCC6)c(OC)cc5c3O2)-c2ccc(Sc3ccccc3C(F)(F)F)cc2C4(CCC)CCC)cc1] | 4 |
| 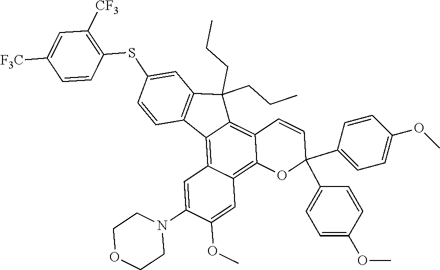 [SMILES: CCCC1(CCC)c2cc(Sc3ccc(C(F)(F)F)cc3C(F)(F)F)ccc2-c2c1c1c(c3cc(OC)c(N4CCOCC4)cc23)OC(c2ccc(OC)cc2)(c2ccc(OC)cc2)C=C1] | 5 |
| 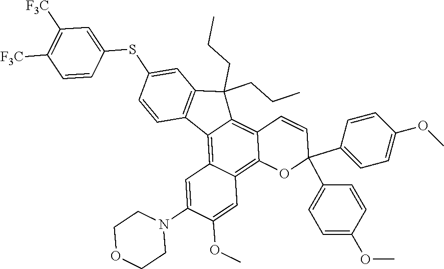 [SMILES: CCCC1(CCC)c2cc(Sc3ccc(C(F)(F)F)c(C(F)(F)F)c3)ccc2-c2c1c1c(c3cc(OC)c(N4CCOCC4)cc23)OC(c2ccc(OC)cc2)(c2ccc(OC)cc2)C=C1] | 6 |
| 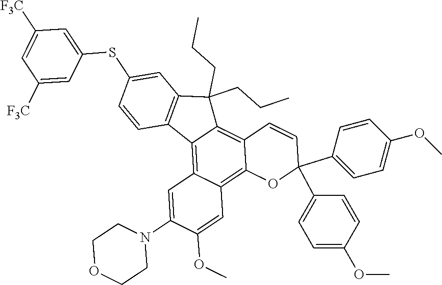 [SMILES: CCCC1(CCC)c2cc(Sc3cc(C(F)(F)F)cc(C(F)(F)F)c3)ccc2-c2c1c1c(c3cc(OC)c(N4CCOCC4)cc23)OC(c2ccc(OC)cc2)(c2ccc(OC)cc2)C=C1] | 7 |
| 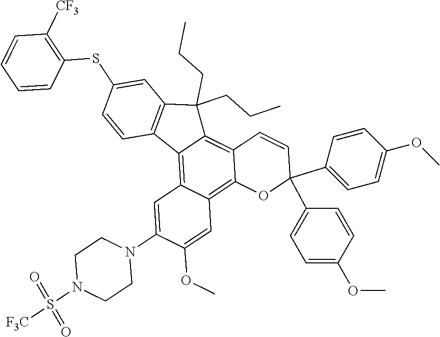 [SMILES: CCCC1(CCC)c2cc(Sc3ccccc3C(F)(F)F)ccc2-c2c1c1c(c3cc(OC)c(N4CCN(S(=O)(=O)C(F)(F)F)CC4)cc23)OC(c2ccc(OC)cc2)(c2ccc(OC)cc2)C=C1] | 8 |
| 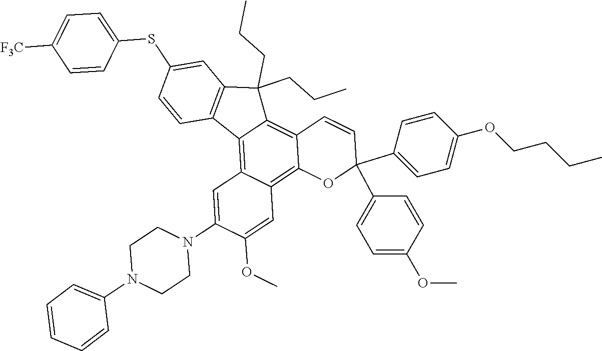 [SMILES: CCCCOc1ccc(C2(c3ccc(OC)cc3)C=Cc3c4c(c5cc(N6CCN(c7ccccc7)CC6)c(OC)cc5c3O2)-c2ccc(Sc3ccc(C(F)(F)F)cc3)cc2C4(CCC)CCC)cc1] | 9 |
| 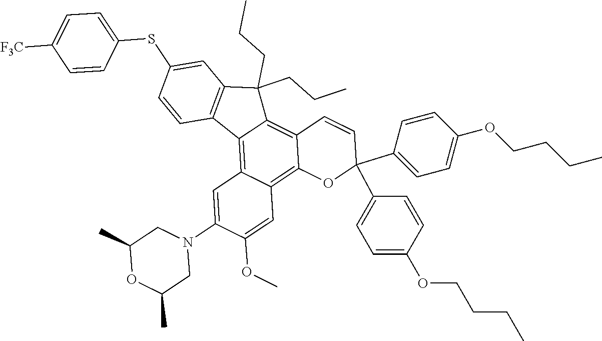 [SMILES: CCCCOc1ccc(C2(c3ccc(OCCCC)cc3)C=Cc3c4c(c5cc(N6C[C@@H](C)O[C@@H](C)C6)c(OC)cc5c3O2)-c2ccc(Sc3ccc(C(F)(F)F)cc3)cc2C4(CCC)CCC)cc1] | 10 |
| 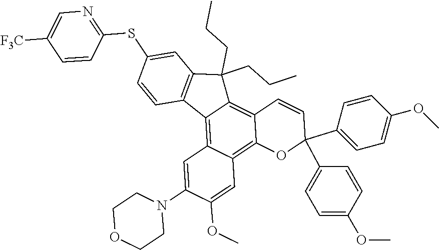 [SMILES: CCCC1(CCC)c2cc(Sc3ccc(C(F)(F)F)cn3)ccc2-c2c1c1c(c3cc(OC)c(N4CCOCC4)cc23)OC(c2ccc(OC)cc2)(c2ccc(OC)cc2)C=C1] | 11 |
| 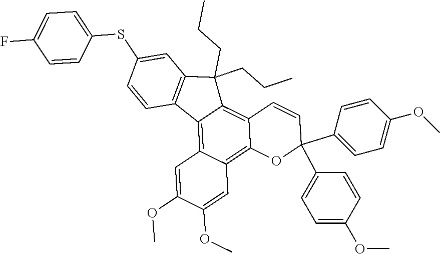 [SMILES: CCCC1(CCC)c2cc(Sc3ccc(F)cc3)ccc2-c2c1c1c(c3cc(OC)c(OC)cc23)OC(c2ccc(OC)cc2)(c2ccc(OC)cc2)C=C1] | CE12 |
| 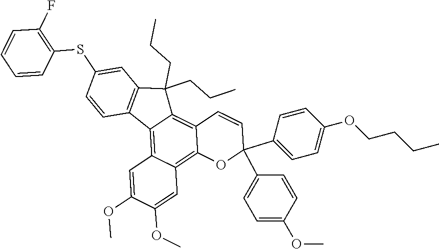 [SMILES: CCCCOc1ccc(C2(c3ccc(OC)cc3)C=Cc3c4c(c5cc(OC)c(OC)cc5c3O2)-c2ccc(Sc3ccccc3F)cc2C4(CCC)CCC)cc1] | CE13 |
| 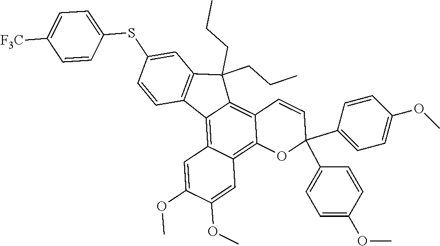 [SMILES: CCCC1(CCC)c2cc(Sc3ccc(C(F)(F)F)cc3)ccc2-c2c1c1c(c3cc(OC)c(OC)cc23)OC(c2ccc(OC)cc2)(c2ccc(OC)cc2)C=C1] | 14 |
| 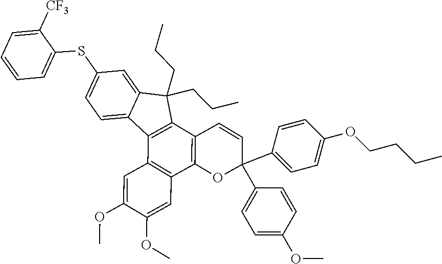 [SMILES: CCCCOc1ccc(C2(c3ccc(OC)cc3)C=Cc3c4c(c5cc(OC)c(OC)cc5c3O2)-c2ccc(Sc3ccccc3C(F)(F)F)cc2C4(CCC)CCC)cc1] | 15 |

### Part-2

### Evaluation of the Indenonaphthopyran Compounds of Part-1

Each of the of the indenonaphthopyran compounds of Part-1, were incorporated into a polyurethane coating system as described in U.S. Pat. No. 8,608,988 B2, examples 1-3 at the same mole % and applied at the same coating thickness on 2″×2″ (5.1 cm×5.1 cm) test chips made from CR-39® monomer (PPG Industries, Inc.). All coated test chips were cured at 125° C. for 1 hour.

Each of the coated test chips was conditioned by first being exposed to 365 nanometer ultraviolet light for 10 minutes at a distance of about 14 centimeters to activate the photochromic materials within the coating. The UVA (315 to 380 nm) irradiance at the chip was measured with a LICOR® Model Li-1800 spectroradiometer and found to be 22.2 watts per square meter. Each of the test chips was then placed under a 500 watt, high intensity halogen lamp for 10 minutes at a distance of about 36 centimeters to bleach (inactivate) the photochromic materials. The illuminance at chip was measured with the LICOR® spectroradiometer and found to be 21.9 Klux. The coated test chips then were kept in a dark environment at room temperature (i.e., from 70° F. to 75° F., or 21° C. to 24° C.) for at least 1 hour prior to testing/measurement on an optical bench. Prior to optical bench measurement, the coated test chips were measured for ultraviolet absorbance at 390 nanometers.

Percent transmission (% T) for each of the coated test chips was determined using the CIE Y value in accordance with CIE 15: 2004 colorimetry using a D 65 illuminant and 100 observer. The a* and b* values as used herein refers to the a* and b* values measured in accordance with CIE 15: 2004 space colorimetry, employing a D 65 illuminant and 100 observer, using an UltraScan Pro (Hunter Labs).

The BMP optical bench was fitted with two 150-watt ORIEL® Model #66057 Xenon arc lamps at right angles to each other. The light path from Lamp 1 was directed through a 3 mm SCFIOTT® KG-2 band-pass filter and appropriate neutral density filters that contributed to the required UV and partial visible light irradiance level. The light path from Lamp 2 was directed through a 3 mm SCFIOTT® KG-2 band-pass filter, a SCFIOTT® short band 400 nm cutoff filter and appropriate neutral density filters in order to provide supplemental visible light illuminance. A 2 inch×2 inch (5.1 cm×5.1 cm) 50% polka dot beam splitter, at 450 to each lamp is used to mix the two beams. The combination of neutral density filters and voltage control of the Xenon arc lamp were used to adjust the intensity of the irradiance. Proprietary software (i.e., BMPSoft version 2.1e) was used on the BMP to control timing, irradiance, air cell and sample temperature, shuttering, filter selection and response measurement. A ZEISS® spectrophotometer, Model MCS 501, with fiber optic cables for light delivery through the coated test chip was used for response and color measurement. Photopic response measurements were collected on each coated test chip. The power output of the optical bench, i.e., the dosage of light that the coated test chip was exposed to, was adjusted to 6.7 Watts per square meter (W/m²) UVA, integrated from 315-380 nm and 50 Klux illuminance, integrated from 380-780 nm. Measurement of this power setpoint was made using an irradiance probe and the calibrated Zeiss spectrophotometer. The coated test chip sample cell was fitted with a quartz window and self-centering sample holder. The temperature in the sample cell was controlled at 23° C. through the software with a modified Facis, Model FX-10, environment simulator. Measurement of the coated test chips' dynamic photochromic response and color measurements was made using the same Zeiss spectrophotometer, with fiber optic cables for light delivery from a tungsten halogen lamp and through the sample. The collimated monitoring light beam from the fiber optic cable was maintained perpendicular to the test sample while passing through the coated test chip sample and directed into a receiving fiber optic cable assembly attached to the spectrophotometer. The exact point of placement of the coated test chip sample in the sample cell was where the activating xenon arc beam and the monitoring light beam intersected to form two concentric circles of light. The angle of incidence of the xenon arc beam at the sample placement point was 30° from perpendicular.

Response measurements, in terms of a change in optical density (AOD) from the unactivated or bleached state to the activated or colored state were determined by establishing the initial unactivated transmittance, opening the shutter from the Xenon lamp(s) and measuring the transmittance through activation at selected intervals of time. The change in optical density was determined according to the formula:

$$Δ OD = {Log}_{( 10 )} ( \% Tb / \% Ta )$$

With reference to the above ΔOD formula: % Tb is the percent transmission in the bleached state; and % Ta is the percent transmission in the activated state. The ΔOD at saturation is after 15 minutes of activation and the Fade Half Life (T½) value is the time interval in seconds for the ΔOD of the activated form of the photochromic material in the coating to reach one half the fifteen minute ΔOD at 73.4° F. (23° C.), after removal of the activating light source.

The results of the above described testing and evaluation are summarized in the following Tables 2 and 3.

TABLE 2

| Compound/ | | Bleach | | | Photochromic Performance | | | |
|---|---|---|---|---|---|---|---|---|
| Example | 390 nm | Ultrascan XE 10° | | | | | | Fade |
| No. | Abs | Y | a* | b* | Y | a* | b* | T_{1/2 (sec)} |
| CE1 | 2.3 | 89.9 | −1.9 | 5.1 | 13.2 | 8.2 | 28.3 | 63 |
| 3 | 2.1 | 90.4 | −1.6 | 4.5 | 17.3 | 11.0 | 27.1 | 46 |
| CE2 | 2.1 | 89.8 | −1.6 | 4.8 | 13.7 | 9.2 | 28.1 | 60 |
| 4 | 2.3 | 89.6 | −1.6 | 5.1 | 15.8 | 10.5 | 26.6 | 50 |
| CE12 | 1.8 | 90.8 | −1.1 | 2.4 | 23.2 | −18.4 | 27.0 | 50 |
| 14 | 1.8 | 91.0 | −0.9 | 2.2 | 29.1 | −13.2 | 25.2 | 38 |
| CE13 | 1.6 | 90.3 | −1.0 | 2.7 | 24.2 | −16.4 | 26.0 | 46 |
| 15 | 1.8 | 90.6 | −1.1 | 2.8 | 26.7 | −14.3 | 25.6 | 40 |

TABLE 3

| Compound/ | | Bleach | | | Photochromic Performance | | | |
|---|---|---|---|---|---|---|---|---|
| Example | 390 nm | Ultrascan XE 10° | | | | | | Fade |
| No. | Abs | Y | a* | b* | Y | a* | b* | T_{1/2 (sec)} |
| 5 | 2.3 | 90.4 | −1.7 | 4.7 | 18.8 | 12.6 | 26.0 | 36 |
| 6 | 2.3 | 90.2 | −2.0 | 5.8 | 18.2 | 12.4 | 27.2 | 41 |
| 7 | 2.4 | 90.5 | −1.7 | 4.7 | 17.7 | 13.2 | 27.1 | 40 |
| 8 | 2.0 | 90.2 | −1.7 | 4.4 | 20.3 | −1.3 | 25.6 | 40 |
| 9 | 2.2 | 89.8 | −1.6 | 5.1 | 17.1 | 13.0 | 25.7 | 48 |
| 10 | 2.3 | 89.6 | −1.6 | 5.4 | 14.9 | 15.6 | 23.0 | 49 |
| 11 | 1.9 | 90.5 | −1.4 | 4.1 | 19.2 | 11.9 | 26.2 | 44 |

The data summarized in Table 2 demonstrates that indenonaphthopyran compounds according to the present invention (having (perfluoroalkyl)aryl)thio substituents at Position-11) provide improved fade speed, as compared to comparative indenonaphthopyran compounds (having (fluoroaryl)thio substituents at Position-11), without a significant sacrifice in the darkness of the activated state. The data summarized in Table 3 further demonstrates the fast fade speeds provided by indenonaphthopyran compounds according to the present invention having various groups at Position-7 and Position-11 thereof.

The present invention has been described with reference to specific details of particular embodiments thereof. It is not intended that such details be regarded as limitations upon the scope of the invention except insofar as to the extent that they are included in the accompanying claims.

What is claimed is:

1. An indenonaphthopyran compound represented by the following Formula (I), 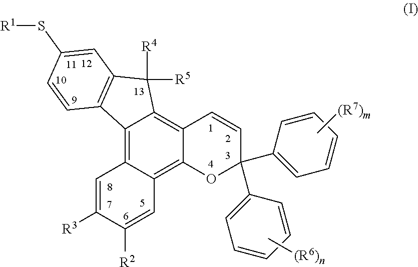
wherein,
m is from 0 to 3;
n is from 0 to 3;
R¹ is aryl substituted with at least one perfluoroalkyl group, or heteroaryl substituted with at least one perfluoroalkyl group;
R² is alkoxy;
R³ is alkoxy, amino, or substituted or unsubstituted nitrogen-containing heterocycle, wherein when R³ is other than alkoxy, R³ is covalently bonded to position-7 by a nitrogen atom;
R⁴ and R⁵ are each independently selected from,
substituted or unsubstituted alkyl; or
R⁴ and R⁵ together form a substituted or unsubstituted spirocyclic ring; and
R⁶ independently for each n, and R⁷ independently for each m, in each case are independently selected from,
amino;
substituted or unsubstituted nitrogen-containing heterocycle;
a halo group;
substituted or unsubstituted alkyl;
substituted or unsubstituted alkoxy;
perfluoroalkyl; or
substituted or unsubstituted alkylthio.

2. The indenonaphthopyran compound of claim 1 wherein,
R¹ is aryl substituted with at least one linear or branched C₁-C₁₀ perfluoroalkyl group, or heteroaryl substituted with at least one linear or branched C₁-C₁₀ perfluoroalkyl group;
R² is linear or branched C₁-C₁₀ alkoxy;
R³ is selected from,
linear or branched C₁-C₁₀ alkoxy,
secondary or tertiary amino represented by the following Formula (II), 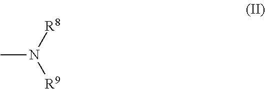
wherein for Formula (II), R⁸ and R⁹ are each independently selected from hydrogen, substituted or unsubstituted alkyl, substituted or unsubstituted cycloalkyl, or substituted or unsubstituted aryl, provided that at least one of R⁸ and R⁹ is other than hydrogen,
substituted or unsubstituted piperidino,
substituted or unsubstituted morpholino,
substituted or unsubstituted C₃-C₆ cyclic amide, or
substituted or unsubstituted piperazino represented by the following Formula (III), 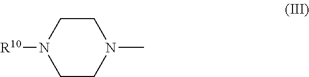
wherein for Formula (III),
R¹⁰ is selected from hydrogen, substituted or unsubstituted alkyl, substituted or unsubstituted cycloalkyl, substituted or unsubstituted aryl, alkyl sulfonyl, or perhaloalkyl sulfonyl.

3. The indenonaphthopyran compound of claim 2 wherein,
R¹ is aryl substituted with at least one linear or branched C₁-C₆ perfluoroalkyl group, or heteroaryl substituted with at least one linear or branched C₁-C₆ perfluoroalkyl group;
R² is linear or branched C₁-C₆ alkoxy;
R³ is selected from,
linear or branched C₁-C₆ alkoxy,
secondary or tertiary amino represented by Formula (II),
wherein for Formula (II), R⁸ and R⁹ are each independently selected from hydrogen, substituted or unsubstituted linear or branched C₁-C₆ alkyl, substituted or unsubstituted C₅-C₇ cycloalkyl, or substituted or unsubstituted aryl, provided that at least one of R⁸ and R⁹ is other than hydrogen,
unsubstituted piperidino,
substituted or unsubstituted morpholino,
unsubstituted C₃-C₆ cyclic amide, or
substituted or unsubstituted piperazino represented by Formula (III),
wherein for Formula (III),
R¹⁰ is selected from hydrogen, substituted or unsubstituted linear or branched C₁-C₆ alkyl, substituted or unsubstituted phenyl, or linear or branched C₁-C₆ perhaloalkyl sulfonyl,
R⁴ and R⁵ are each independently selected from,
unsubstituted linear or branched C₁-C₆ alkyl; and
R⁶ independently for each n, and R⁷ independently for each m, in each case are independently selected from,
substituted or unsubstituted piperidino,
substituted or unsubstituted morpholino,
substituted or unsubstituted piperazino independently as described with reference to Formula (III),
fluoro, chloro, or bromo,
substituted or unsubstituted linear or branched C₁-C₆ alkyl, or
substituted or unsubstituted linear or branched C₁-C₆ alkoxy.

4. The indenonaphthopyran compound of claim 3 wherein,
R¹ is phenyl substituted with at least one linear or branched C₁-C₄ perfluoroalkyl group, or pyrdinyl substituted with at least one linear or branched C₁-C₄ perfluoroalkyl group;
R² is linear or branched C₁-C₄ alkoxy;
R³ is selected from,
linear or branched C₁-C₄ alkoxy,
secondary or tertiary amino represented by Formula (II),
wherein for Formula (II), R⁸ and R⁹ are each independently selected from unsubstituted linear or branched C₁-C₄ alkyl, or linear or branched C₁-C₄ perhaloalkyl, provided that at least one of R⁸ and R⁹ is linear or branched C₁-C₄ perhaloalkyl,
substituted or unsubstituted piperidino,
substituted or unsubstituted morpholino,
substituted piperazino represented by Formula (III),
wherein for Formula (III),
R¹⁰ is selected from substituted or unsubstituted linear or branched C₁-C₄ alkyl, substituted or unsubstituted phenyl, or linear or branched C₁-C₄ perhaloalkyl sulfonyl, or
unsubstituted C₃-C₆ cyclic amide;
R⁴ and R⁵ are each independently selected from,
unsubstituted linear or branched C₁-C₄ alkyl; and
R⁶ independently for each n, and R⁷ independently for each m, in each case are independently selected from,
unsubstituted piperidino,
unsubstituted morpholino,
fluoro, chloro, or bromo,
unsubstituted linear or branched C₁-C₄ alkyl, or
unsubstituted linear or branched C₁-C₄ alkoxy.

5. The indenonaphthopyran compound of claim 4, provided that at least one of R⁶ and R⁷ is unsubstituted linear or branched C₁-C₄ alkoxy

6. A photochromic composition comprising the indenonaphthopyran compound of claim 1.

7. A photochromic article comprising the indenonaphthopyran compound of claim 1, wherein the photochromic article is selected from the group consisting of ophthalmic articles, display articles, windows, mirrors, active liquid crystal cell articles, and passive liquid crystal cell articles.

8. The photochromic article of claim 7, wherein the photochromic article is selected from ophthalmic articles, and the ophthalmic articles are selected from corrective lenses, non-corrective lenses, contact lenses, intra-ocular lenses, magnifying lenses, protective lenses, and visors.
